(19) United States
(12) Patent Application Publication
(10) Pub. No.: US 2008/0201404 A1
(43) Pub. Date: Aug. 21, 2008

(54) System for Affecting the Overall Behavior of a Peer to Peer Network

(75) Inventors: Alexander Lazovsky, Petach Tikvah (IL); Alexander Zaidelson, Kiryat Ono (IL); Jhanna Lazovsky, Petach Tikvah (IL); Ilya Pashkovsky, Rishon Lezion (IL); Camuel Gilyadov, Petach Tikvah (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignee: NETBARRAGE LTD., Petach Tikvah (IL)

(21) Appl. No.: 11/915,035

(22) PCT Filed: May 22, 2006
(86) PCT No.: PCT/IL2006/000601

§ 371 Date: May 2, 2008

Related U.S. Application Data
(60) Provisional application No. 60/684,361, filed on May 24, 2005.

(51) Int. Cl. G06F 15/16

(52) U.S. Cl. 709/202

(57) ABSTRACT

The invention relates to a strategic peer to peer system for affecting the overall behavior of a peer to peer network, which comprises: (a) A central server having communication with a plurality of remote agent machines; (b) A task interface within said central server for enabling an operator to define a task for said remote agent machines, each task comprises a strategy and specific parameters for said strategy; (c) A plurality of remote agent machines, for each receiving said task from said central server, and each creating a large number, several hundreds or more, of peer to peer virtual users that are introduced into a peer to peer network, all said virtual users performing same strategy in said peer to peer network.

### FIELD OF THE INVENTION

The present invention relates to the field of management and control of a peer-to-peer network. More particularly, the present invention relates to a strategic system which influences the overall behavior of a public peer to peer network according to a defined strategy.

### BACKGROUND OF THE INVENTION

In recent years, the sharing of content via a peer-to-peer network has become a major application of a broadband Internet communication. Today, more than 60 million Americans use peer-to-peer communication for file sharing, and more than 400 millions of people do so worldwide.

There exists a number of peer-to-peer file trading protocols, the leading ones being BitTorrent, ED2K, FastTrack, Gnutella and Overnet. Each of said protocols has a number of peer-to-peer file sharing applications that use it. For example, the FastTrack protocol is used by Kazaa and Kazaa Lite, the ED2K protocol is used by eMule, eDonkey, etc.

New applications based on peer-to-peer networks have been introduced recently, such as new generation communications over IP—a serverless communications system, based on peer-to-peer principles. Serverless network architecture is a revolutionary concept that effectively removes the need for a centralized system, switch, or server to control the communication process. It probably marks the next most significant step in computer networking evolution since the creation of mainframes and the subsequent migration towards existing client/server architecture. For example, companies such as Skype, Peerio and others have utilized this new approach to create and operate peer-to-peer based voice over IP services.

Most Peer to Peer file sharing networks are anonymous, i.e. no proven identity information is required from the users who join or use them. Each network automatically provides every new user with a unique identifier. On the other hand, network addresses of users that share and/or download a file are available to all other users of the network. When a user begins downloading a file, he automatically opens that file for sharing with others, even when the full file has not been yet downloaded. The search mechanisms of most peer to peer networks make it possible for any single user to find the addresses of other users who are either sharing the full file or they are in the process of downloading that file.

Presently, the traffic generated by peer-to-peer applications constitutes about 80% of overall traffic passing through ISPs. The peer-to-peer file sharing applications generate high amount of traffic. That large amount of traffic adversely affects the overall quality of service for ISPs customers. Users that employ applications, such as HTTP, voice-over-IP, e-mail and others, experience worse speeds and quality of connection.

In another aspect, the simplicity and convenience of performing worldwide sharing, has opened the way for a wide infringement of copyright. It is widely known that most of the unauthorized content sharing is performed by means of peer-to-peer networks. According to industry researches the online piracy growth is estimated at 10% annually at the least. The recent years have shown a growing number of attempts to enforce the Digital Millennium Copyright Act (DMCA), signed in 1998. However, the legal system is still unable to effectively combat online piracy. The music industry during the past five years has seen a decline in shipments of CDs of more than 20 percent, and that has translated into real economic harm.

As said, most peer to peer communication is anonymous in terms of the identity of the network users. However, the facts that a specific user can search the full network for a specific content, or that he can determine those specific contents that are being requested or downloaded at each specific moment opens the way for new options. For example, it is possible to exploit the peer to peer network for researching the preferences of users, for example, in terms of finding those contents that are most popular in the network (i.e., those contents that are requested most). Furthermore, it is even possible to determine those preferences in terms of geographic locations, as the IP addresses of the user are available. Such a geographic determination is valuable to the content owners, retailers, etc. as they can use such preference information for survey and marketing purposes.

In another aspect, a content owner may wish to show popularity of a specific content by showing that more people offer said specific content, by including it in their list of shared files. This may induce users to perceive such file as more desirable. The system of the present invention, among others, can be used for a massive offering of content in peer to peer networks. In other words, such a massive offering may be used for the purpose of marketing, for example, by distributing a content preview, advertisement, or paid content.

Furthermore, a content owner may wish to combat illegal distribution of his content in a peer to peer network by introducing a large amount of users who appear to own and share certain content, while what they actually share is not what it appears to be. In this manner, the content owners can disturb illegal distribution of their authentic material via the peer to peer network.

All said purposes can be achieved by introducing a large amount of peer to peer users who exhibit a certain behavior that affects the global behavior of the network. The present invention provides a system that can introduce into the peer to peer network a large amount of virtual users, to which a specific behavior can be assigned. Furthermore, the system of the invention can introduce said additional users from different geographic locations, according to the needs.

It is therefore an object of the present invention to provide a system which is capable of performing each of abovementioned strategic tasks, as well as other tasks that require a large number of virtual users.

It is still another object of the present invention to provide a system which enables selection between predefined tasks, and activating the system accordingly.

It is still another object of the invention to provide a global system that is able to activate several tasks simultaneously.

Other characteristics and objects of the present invention will become apparent as the description proceeds.

### SUMMARY OF THE INVENTION

The present invention relates to a strategic peer to peer system for affecting the overall behavior of a peer to peer network, which comprises: (a) A central server having communication with a plurality of remote agent machines; (b) A task interface within said central server for enabling an operator to define a task for said remote agent machines, each task comprises a strategy and specific parameters for said strategy; (c) A plurality of remote agent machines, for each receiving said task from said central server, and each creating a large number, several hundreds or more, of peer to peer virtual users that are introduced into a peer to peer network, all said virtual users performing same strategy in said peer to peer network.

Preferably, said remote agent machines are geographically distributed.

Preferably, said virtual users are indistinguishable from conventional users of the peer to peer network.

Preferably, said strategy is selected from a group comprising: (a) offering a file for download in a peer to peer network; (b) downloading a file in a peer to peer network; (c) searching for users who have a certain file in a peer to peer network; and (d) preventing users from downloading certain content items in a peer to peer network.

Preferably, the task includes: a strategy to be performed, specific parameters for the strategy, and the number of virtual users that have to be created.

Preferably, the task further includes the number of virtual user that have to be created by each remote agent machine.

Preferably, each remote agent machine has a plurality of peer to peer protocols, and each such machine is capable of creating a virtual user selectively in one of said protocols, as assigned in said task.

Preferably, each remote agent machine comprises an address pool, for assigning to each created virtual user its unique address.

Preferably, each remote agent machine comprises a storage for storing: offered content, downloaded content, or data accumulated from the network by said virtual users.

Preferably, data accumulated by said virtual users are conveyed from the corresponding remote agent machines to the central server for analysis.

Preferably, the central server further comprises a database

Preferably, said database stores a content that is conveyed to the remote agent machines, for being offered for sharing by said virtual users.

Preferably, said database of the server stores accumulated data which is collected by the virtual users, and received from the corresponding remote agent machines.

Preferably, new strategies can be added to the central server.

Preferably, each agent machine performs simultaneously several tasks, each task involves creation and activation of at lest several hundreds of virtual users.

### BRIEF DESCRIPTION OF THE DRAWINGS

In the drawings:

FIG. 1 is a block diagram illustrating the general structure of a system according to an embodiment of the present invention; and

FIG. 2 is a block diagram illustrating the general structure of a remote agent machine according to an embodiment of the present invention.

### DETAILED DESCRIPTION OF PREFERRED EMBODIMENTS

As said, the present invention provides a strategic system which globally affects the behavior of a peer to peer network. As will be discussed in more details, the system of the invention achieves this goal by the creation and introduction into the peer to peer network a mass amount of virtual peer to peer users. The term “virtual” is used herein to indicate that the user which the system creates is not a conventional user, i.e., it is not a user which is directed and operated by a human being. On the other hand, each “virtual user” is a machine created and operated user, which is in itself, behaves like a regular human-operated user, and is therefore undistinguishable by external entities from said human operated users of the network. When such a mass amount of virtual users is introduced into the peer to peer network, and when all of said mass virtual users have certain predefined characteristics (i.e., behavior), they form a statistically considerable weight that affects the overall behavior of the network. For example, if all the virtual users offer a same content item, such content item will appear to have high availability to other users which will induce them to download the item.

It is therefore an object of the present invention to provide a strategic system which is capable of creating a mass amount of virtual users, and to assign to said mass amount of users a certain behavior, as defined. It is another object of the invention to enable changing the behavior of the virtual users, when desired.

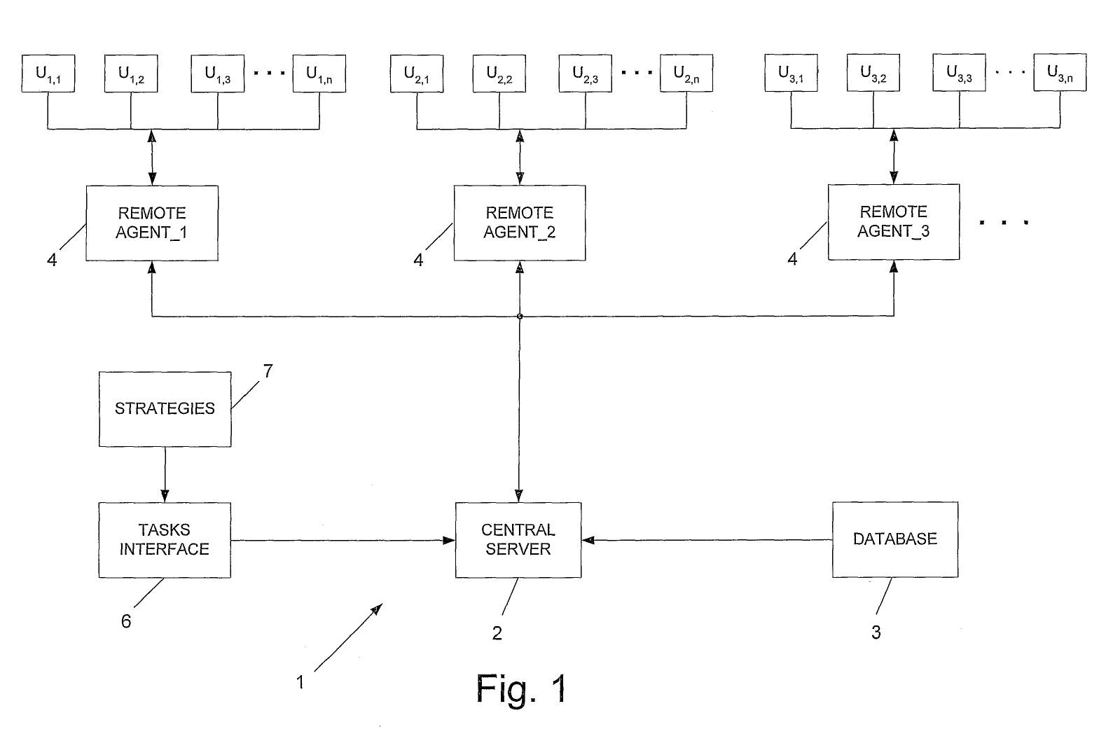

FIG. 1 describes the general structure of the system 1 of the invention. The system comprises a central server 2, and a plurality of remote agent machines 4. Each remote agent machine is capable of producing a plurality, usually thousands of peer to peer virtual users as defined. Each virtual user is created for performing a specific task, and in general, thousands of users on more than one agent are created for performing a same task. The task which is assigned for each user includes a strategy, and parameters specific to this strategy. Said tasks are assigned by the operator of the system by means of task interface 6, and they are selected from strategies repository 7. Database 3 contains contents for distribution, and if reports are received from the various users by means of the agents, said reports are also collected and stored in database 3.

As said, the operator of the system defines the task that is assigned to the virtual users by means of interface 6. A task comprises a strategy to be applied, parameters for the strategy, and the number of virtual users for performing the task. For example, the strategy can be one of the following:
a. offer a file for download in ED2K-based network;
b. download a file in FastTrack-based network;
c. search for users who have a certain file in BitTorrent-based network (for example, for statistics purposes);
d. Offer a file for download in ED2K network, and serve wrong data according to specific pattern in order to prevent users from downloading copyrighted materials

Each strategy has its own set of parameters that need to be provided, in order to create a valid task. For example, offering a file to download strategy may include the parameters of: filename, the content itself, file size, etc.

The number of virtual users that need to be created by each machine can also be specified. For example, in a specific task, this indication may be 1000 users from agent_machine_{—}1, 700 from agent_machine_{—}2, 3000 from agent_machine_{—}3, etc.

The task may be assigned for beginning immediately without assigning a time frame, or it may be defined to span a specific period.

The strategies within the strategies repository 7 may be updated from time to time, by defining new strategies. In one embodiment the strategies may be represented by C language libraries.

It is advantages that the remote agent machines be distributed geographically, due to the following main reasons:
(a) to be able to provide better service in various locations;
(b) in order to evenly distribute the virtual users over various geographic locations, in order to prevent easy identification of the virtual users, or their behavior pattern by a third party;
(c) In the event of a certain IP Address range being blocked by peer to peer network, such setup allows to easily replace the blocked IP range with a new one.

After defining a task by the system operator, the task is conveyed to the various agent machines for execution. Some strategies may involve reporting back the results from the users to the central server 2, and said reports may be accumulated in database 3 for further analysis.

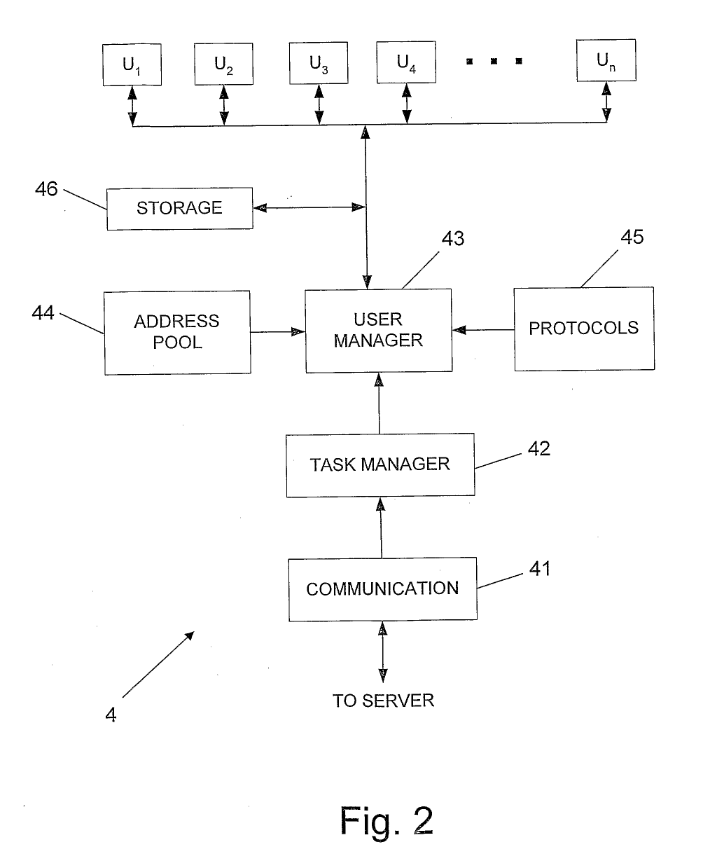

FIG. 2 describes the general structure of an agent machine 4. The communication module 41 performs communication with central server 2. Task manager 42 receives the assigned tasks from server 2, and it manages all the tasks that are performed by the various virtual users. User manager 43 creates the plurality of virtual users in the appropriate protocol 45 as selected, according to the task it receives from the task manager 42. The address pool 44 contains the list of IP address and ports that can be used for creating virtual users on each remote agent machine. The user manger 43 assigns to each virtual user one address from the address pool 44. Storage 46, can be used for storing the content to be distributed (in case of distribution-related strategies), and/or downloaded content (in case of strategies involving downloading content from peer-to-peer networks), when required. Optionally, it may be used for storing other types of data.

After being created by user manager 43, each virtual user connects to a peer to peer network using the corresponding protocol, and starts executing its task.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. A strategic peer to peer system for affecting the overall behavior of a peer to peer network, which comprises:
A central server having communication with a plurality of remote agent machines;
A task interface within said central server for enabling an operator to define a task for said remote agent machines, each task comprises a strategy and specific parameters for said strategy;
A plurality of remote agent machines, for each receiving said task from said central server, and each creating a large number, several hundreds or more, of peer to peer virtual users that are introduced into a peer to peer network, all said virtual users performing same strategy in said peer to peer network.

2. System according to claim 1, wherein said remote agent machines are geographically distributed.

3. System according to claim 1, wherein said virtual users are indistinguishable from conventional users of the peer to peer network.

4. System according to claim 1, wherein said strategy is selected from a group comprising:
offering a file for download in a peer to peer network;
downloading a file in a peer to peer network;
searching for users who have a certain file in a peer to peer network; and
preventing users from downloading certain content items in a peer to peer network.

5. System according to claim 1, wherein the task includes: a strategy to be performed, specific parameters for the strategy, and the number of virtual users that have to be created.

6. System according to claim 5, wherein the task further includes the number of virtual user that have to be created by each remote agent machine.

7. System according to claim 1, wherein each remote agent machine has a plurality of peer to peer protocols, and each such machine is capable of creating a virtual user selectively in one of said protocols, as assigned in said task.

8. System according to claim 1, wherein each remote agent machine comprises an address pool, for assigning to each created virtual user its unique address.

9. System according to claim 1, wherein each remote agent machine comprises a storage for storing: offered content, downloaded content, or data accumulated from the network by said virtual users.

10. System according to claim 1, wherein data accumulated by said virtual users are conveyed from the corresponding remote agent machines to the central server for analysis.

11. System according to claim 1, wherein the central server further comprises a database

12. System according to claim 11 wherein said database stores a content that is conveyed to the remote agent machines, for being offered for sharing by said virtual users.

13. System according to claim 11, wherein said database of the server stores accumulated data which is collected by the virtual users, and received from the corresponding remote agent machines.

14. System according to claim 1 wherein new strategies can be added to the central server.

15. System according to claim 1, wherein each agent machine performs simultaneously several tasks, each task involves creation and activation of at lest several hundreds of virtual users.
